(19) United States
(12) Patent Application Publication
(10) Pub. No.: US 2023/0254171 A1
(43) Pub. Date: Aug. 10, 2023

(54) CONTEXTUAL OPTIMIZED MEETINGS

(71) Applicant: CITRIX SYSTEMS, INC., Fort Lauderdale, FL (US)

(72) Inventors: Manbinder Pal Singh, Coral Springs, FL (US); Tie Liu, Nanjing (CN)

(21) Appl. No.: 17/690,717

(22) Filed: Mar. 9, 2022

Related U.S. Application Data
(63) Continuation of application No. PCT/CN2022/075768, filed on Feb. 10, 2022.

(51) Int. Cl. H04L 12/18

(52) U.S. Cl. CPC H04L 12/1831; H04L 12/1827

(57) ABSTRACT

A method, a system, and a computer program product for managing connections of user devices in a network-based conference. A context associated with a transmission of a first data stream in the plurality of data streams to a first user device is monitored. A context associated with a transmission of a second data stream to a second user device is monitored. The first and second user devices are communicatively connected to a network-based conference. Based on the monitoring of the contexts associated with respective transmissions of the first and second data streams, at least one first parameter of the first data stream to the first user device and at least one second parameter of the second data stream to the second user device are adjusted. The adjusted first data stream to the first user device and the adjusted second data stream to the second user device are transmitted.

### BACKGROUND

As a large percentage of workforce switched to working remotely, a greater number of online meetings and online video conferences are being conducted each day. Periodically, during such online meetings and conferences, audio and/or video connection among their participants or attendees may be interrupted for various reasons, e.g., hardware/software malfunction, internet connection, hardware/software configuration, etc. Thus, participants of such meetings periodically use multiple devices to connect to the meetings in hopes of resolving connection issues, providing different input from multiple devices, or for any other reason.

### SUMMARY

In some implementations, the current subject matter relates to a computer implemented method for managing connections of user devices in a network-based conference. The method may include monitoring, using at least one processor, a context associated with a transmission of a first data stream in the plurality of data streams to a first user device in a plurality of user devices, monitoring, using the at least one processor, a context associated with a transmission of a second data stream to a second user device in the plurality of user devices, the first and second user devices being communicatively connected to a network-based conference, adjusting, using the at least one processor, based on the monitoring of the contexts associated with respective transmissions of the first data stream and the second data stream, at least one first parameter of the first data stream to the first user device and at least one second parameter of the second data stream to the second user device, and transmitting, using the at least one processor, the adjusted first data stream to the first user device and the adjusted second data stream to the second user device.

In some implementations, the current subject matter can include one or more of the following optional features. The plurality of data streams may include at least one of the following: an audio data stream, a video data stream, a graphical data stream, a text data stream, and any combination thereof.

In some implementations, the first user device and the second user device may be configured to be used by a user (e.g., a single user) for communicatively connecting to the network-based conference. The monitoring of the contexts of respective transmissions of the first and second data streams may include at least one of the following: determining a capability of at least one of the first and second devices for receiving the respective first and second data streams, determining a use of at least one of the first and second devices by the user for receiving the respective first and second data streams, and any combination thereof. The use of the first and/or second devices by the user may include a contextual use of at least of the first and second devices during the network-based conference. The monitoring of the contexts of respective transmissions of the first and second data streams may include determining presence (e.g., physical presence) of the user proximate to at least one of the first and second user devices.

In some implementations, the first parameter may include at least one of the following parameters: a quality, a bandwidth, a frequency, a transmission rate, and any combination thereof, associated with respective transmissions of the first and second data streams to the first and second user devices. Adjusting of the first parameter may include at least one of allocating, reducing or unchanging, based on the monitoring of the contexts of respective transmissions of the first and second data streams, at least one of the quality, the bandwidth, the frequency, the transmission rate, and any combination thereof associated with respective transmissions of the first and second data streams to at least one of the first and second user devices.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a system for managing device connections in an online meeting, according to some implementations of the current subject matter;

FIGS. 2a-2d illustrate further exemplary systems for managing device connections in an online meeting, according to some implementations of the current subject matter;

FIGS. 3a-c illustrate exemplary process flows for adjusting quality, bandwidth, frequency, transmission rate, etc. and/or other parameters associated with one or more data streams to users' devices in an online meeting based on detecting how user devices are receiving such data streams, according to some implementations of the current subject matter;

FIG. 4 illustrates an example of a network environment, according to some implementations of the current subject matter;

FIG. 5 depicts a block diagram illustrating an example of a computing device, according to some implementations of the current subject matter;

FIG. 6 illustrates a high-level architecture of an example of a virtualization system for implementing the computing system shown in FIG. 1, according to some implementations of the current subject matter;

FIG. 7 illustrates an example of a method, according to some implementations of the current subject matter.

### DETAILED DESCRIPTION

To address the deficiencies of currently available solutions, one or more implementations of the current subject matter provide for an ability to manage connections of multiple devices in an online and/or virtual meetings.

In some implementations, the current subject matter may be configured to provide management of connections (e.g., video, audio, etc.) of different computing devices in a virtual, online, network-based conference/conferencing, web conferencing and/or other network-based connection meeting (“online meeting”). Such management may be useful in one or more of the following exemplary use cases. In exemplary use case, a user may wish to connect to an online meeting using two or more devices simultaneously because of, for instance, an audio issue may be present on one of the user's devices, while another user's device may provide a better quality audio experience and/or yet another user's device may be used for video/display purposes. A single user's use of multiple computing devices for connection to a single online meeting will consume a significant amount of network bandwidth, especially, if multiple users are involved in the online meeting using multiple devices as well. In another exemplary use case, a user may have an online meeting opened in a window running in a background of the user's computing device, while the user is performing various other tasks (and not actively attending the online meeting). In this case, the user's device continues to receive audio/video and/or other signals despite the video not being actively viewed by the user. Again, this consumes unnecessary bandwidth. In yet another user case, the user, while being a participant in an online meeting using the user's device, may have stepped away from the user's device. The user may continue listening to the audio of the online meeting. However, the user's device continues to consume bandwidth/resources for the video stream delivered to the user's device. In yet a further exemplary use case, the user may be a participant in an online meeting while using two computing devices, where on one such device, the user turned off sound and instead, uses the other device to listen to the online meeting. Here, audio bandwidth is being unnecessarily consumed by both devices. As can be understood, there may be many other use cases where unnecessary consumption of bandwidth may occur, which may be addressed by the current subject matter's ability to manage user's (or client's) devices through monitoring and/or optimizing resource usage (e.g., network bandwidth, client resources, etc.).

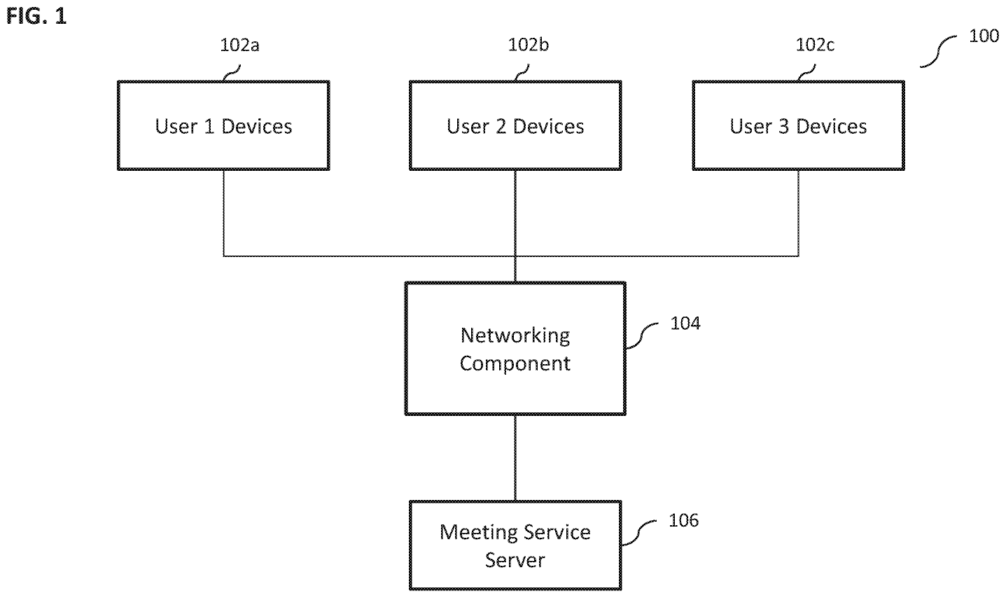

FIG. 1 illustrates an example of a system 100 for managing device connections in an online meeting, according to some implementations of the current subject matter. The devices may be configured to transmit and/or receive various information, data, files, signals, etc., which may include at least one of the following: a video, an audio, an image, a graphics data, a text data, and/or any other information, data, file, signal that may or may not include a video, an audio, an image, a graphics data, a text data, and/or any other data file (“data file”).

The system 100 may be configured to be implemented in one or more servers, one or more databases, a cloud storage location, a memory, a file system, a file sharing platform, a streaming system platform and/or device, and/or in any other platform, device, system, etc., and/or any combination thereof. One or more components of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The components of the system 100 may include any combination of hardware and/or software. In some implementations, such components may be disposed on one or more computing devices, such as, server(s), database(s), personal computer(s), laptop(s), cellular telephone(s), smartphone(s), tablet computer(s), and/or any other computing devices and/or any combination thereof. In some implementations, these components may be disposed on a single computing device and/or can be part of a single communications network. Alternatively, or in addition to, the components may be separately located from one another.

Referring back to FIG. 1, the system 100 may be configured to include one or more attendees, participants, and/or users' devices 102 (i.e., user 1 devices 102a, user 2 devices 102b, user 3 devices 102c), one or more networking components 104, and one or more online meeting service server(s) 106. The meeting service server 106 may be configured to connect and/or execute one or more online virtual meeting software solutions/platforms that may enable one or more devices 102 to communicatively connect with one another using any desired (e.g., wireless, wired, etc.) communications network, such as using networking component(s) 104. The devices 102 may be equipped with video, audio, file sharing, user interface (e.g., screen) sharing, etc. hardware and/or software capabilities as well as any other computing and/or processing capabilities. One or more of the devices 102 may include a single or multiple computing devices and may be configured to be used by a single user and/or multiple different users.

The system 100 may be configured to determine how a particular user's multiple devices 102 may be used (e.g., simultaneously or otherwise) for the purposes of connecting to the online meeting in order to optimize resource usage (e.g., network bandwidth, QoS, etc.). Upon determining use by the users' devices, the system 100 may be configured to adjust and/or change audio, video, etc. stream(s)'s quality separately for each of the users' devices. In some implementations, the adjustments and/or changes may be made using the networking component 104, which may be configured to cause reduction of quality of delivered data stream and/or reduction of available bandwidth associated with data being delivered to a particular user device 102 upon determination that the user is not using the device 102 for a particular purpose (e.g., listening to an audio feed of the online meeting). Alternatively, or in addition, the adjustments and/or changes may include increasing improving quality of delivered data and/or increasing available bandwidth for delivery of data to a particular device, such as, for example, by shifting bandwidth that becomes available as a result of reduction of bandwidth on one user device to another user device. The above determination and/or adjustments/changes may be performed in real-time, e.g., while the user is participating in the online meeting, and/or prior to beginning of the meeting (e.g., by detecting that the user is intending to use one device for audio and another device for video).

For example, in an online meeting involving use of audio and video transmissions, if user's device 1 is being used for audio only during the meeting, the system 100 may be configured to cause transmission of high quality audio to device 1, while quality of the corresponding video stream may be reduced. Alternatively, or in addition, the system 100 may be configured to transmit high quality video stream to user's device 2 and transmit a reduced quality audio stream to device 2, assuming device 2 is not being used for audio. In other scenarios, the system 100 may be configured to detect that one of the user's devices 102 that is connected to the online meeting may have its audio turned off In that case, the networking component 104 may be configured not to transmit any downstream audio data packets to that device. Alternatively, or in addition to, the networking component 104 may be configured to transmit downstream audio data packets to that device to keep alive an audio connection with the device. As can be understood, this arrangement may be configured for any type of data packets.

In some example implementations, the system 100 may be configured to detect a proximity of the user to one or more user's devices during an online meeting (e.g., the user may have stepped away from that device while still being connected to the audio stream of the online meeting). This may be accomplished, for instance, by using one or more sensors that may detect user's presence in front of a camera. To reduce consumed bandwidth, the system 100 may be configured to adjust (e.g., lower) the quality of the video stream delivered to the user's device while the user is away from the user's device. Once the user has returned, the system 100 may be configured to reinstate previous quality of the video stream. Again, as can be understood, adjustment of quality of any type of data stream may be performed by the system 100.

Moreover, in some example implementations, the system 100 may be configured to use a contextual awareness processes to determine whether the user is not actively viewing, listening, etc. a particular data stream that may be delivered to the user's device. For example, the system 100 may be configured to determine that the user is currently performing various tasks that may be unrelated to the online meeting (e.g., by detecting that window of the online meeting is in a background on the user's device and other window(s) are being in the foreground and/or the user is actively performing tasks (e.g., typing a document in a word processing application) in one or more foreground windows). The system 100 may then adjust (e.g., reduce network bandwidth associated with the data stream(s) delivered to the user's device, dropping certain data streams, reducing frequencies associated with data streams, lowering quality of delivered data streams, etc.) the quality of the audio, video, etc. data stream that may be transmitted to the user's device as part of the online meeting.

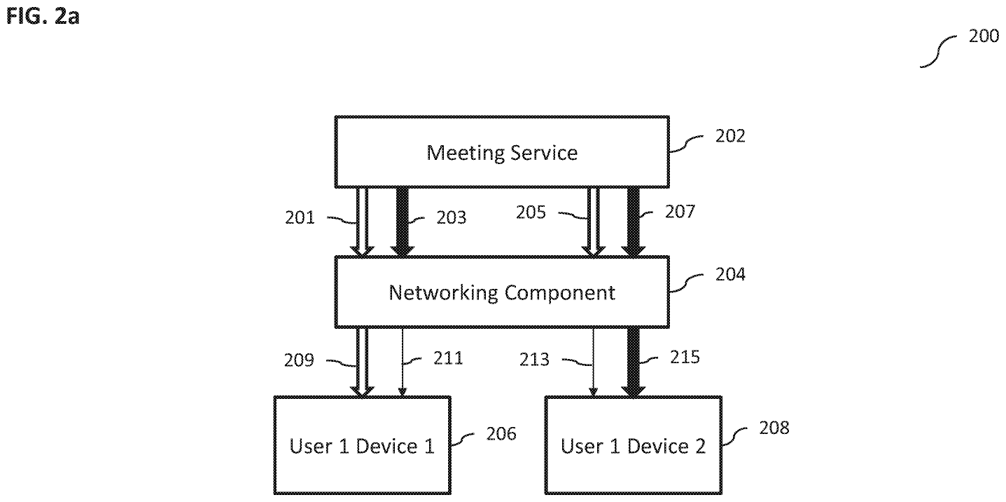

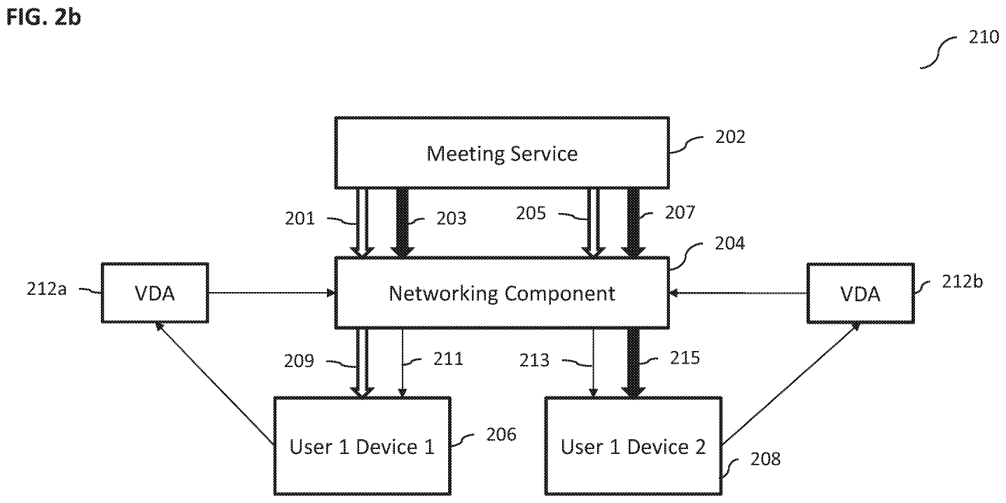

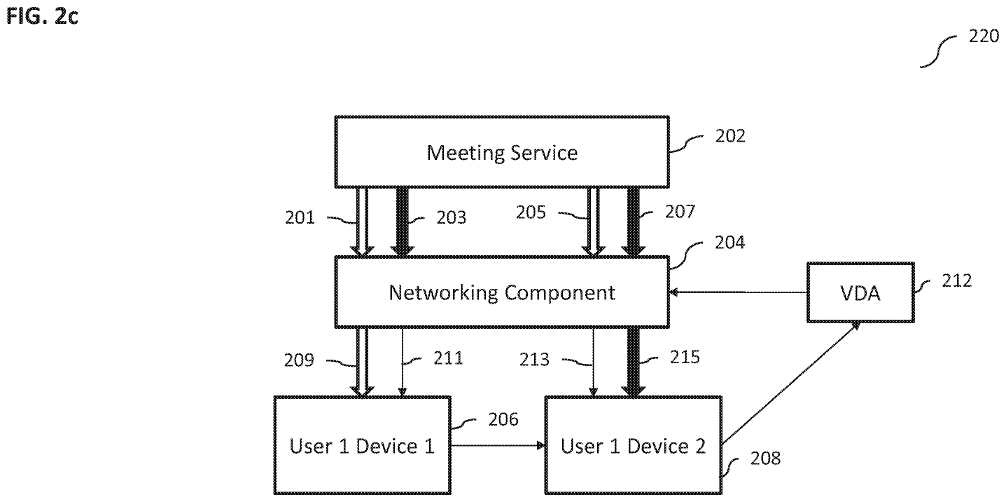

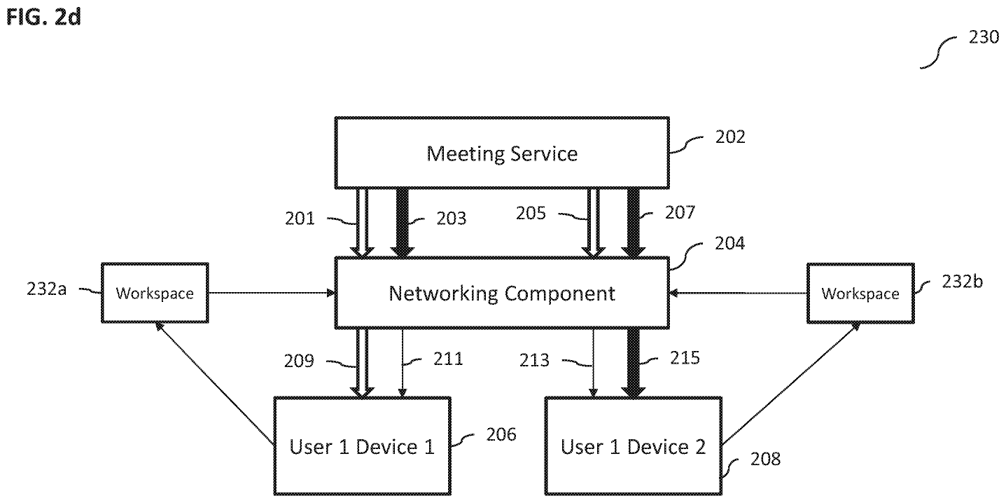

FIGS. 2a-2d illustrate exemplary implementations of systems for managing device connections in an online meeting.

FIG. 2a illustrates an exemplary system 200 for adjusting quality, bandwidth, frequency, transmission rate, etc. and/or other parameters associated with one or more data streams to users' devices in an online meeting based on detecting how user devices are receiving such data streams, according to some implementations of the current subject matter. The system 200 may include a meeting service 202 (similar to meeting services server 106 shown in FIG. 1), a networking component 204 (similar to networking component 104 shown in FIG. 1), and device 1 206 and device 2 208 that may be associated with user 1. The networking component 204 may be configured to include, for example, a software-defined wide area network (SD-WAN) component. The user devices 206 and 208 may be configured to be communicatively coupled with the meeting service 202 using the networking component 204 in an online meeting. During the online meeting, the user devices 206 and 208 may include any type of computing devices (e.g., laptops, personal computers, smartphones, tablet computers, telephones, personal digital assistants, etc.). The user devices 206, 208 may be configured to receive audio and/or video data streams (and/or any other data streams) from the networking component 204, which may originate from the meeting service 202. The connections between components 202, 204, 206, and 208 may be wired, wireless, and/or any other type. As can be understood, there can be more than two user devices that may be connected in the online meeting, e.g., more than one user with more than one user device may be connected in such meeting, a single user with more than two devices may be connected in such meeting, etc.

Upon detecting that user devices 206 and 208 have initiated connection to the online meeting (e.g., using an online meeting software application, a telephone etc.), the meeting service 202 may be configured to transmit an audio data stream 201 and a video data stream 203 to user device 206 and an audio data stream 205 and a video data stream 207 to user device 208. The data streams 201, 203, 205, and 207 may be configured include transmission of one or more data packets and may be configured to be received by the networking component 204. Moreover, the data streams 201-207 may be configured to be transmitted from the meeting service 202 to the networking component 204 using a highest quality available from the meeting service 202.

The component 204 may be configured to detect various parameters associated with connection of the user devices 206 and 208 to the networking component 204. Based on the detected parameters, the networking component 204 may be configured to adjust quality, bandwidth, frequency, transmission rate, etc. associated with transmission of data streams to one or more user devices 206, 208. For example, the networking component 204 may be configured to detect that the user device 206 is connected to the online meeting using audio only (e.g., by calling into the meeting) and not use video; however, user device 208, while being connected to the online meeting, is being used to view the video associated with the online meeting but not use audio. As such, the networking component 204 may be configured to reduce quality, bandwidth, frequency, transmission rate, etc. and/or any other parameters associated with transmission of the video data stream to the user device 206 and transmit such reduced video data stream 211 to the user device 206. Because user device 206 is being used for audio purposes only during the online meeting, the networking component 204 may be configured to transmit highest available quality audio data stream 209 to the user device 206. Further, since user device 208 is being used for video during the online meeting, the networking component 204 may be configured to reduce quality, bandwidth, frequency, transmission rate, etc. and/or any other parameters associated with transmission of the audio data stream to the user device 208 and transmit such reduced audio data stream 213 to the user device 208. Similarly, because user device 208 is being used for video purposes only during the online meeting, the networking component 204 may be configured to transmit highest available quality video data stream 215 to the user device 208.

In some implementations, to determine whether quality, bandwidth, frequency, transmission rate, etc. and/or any other parameters associated with transmission of data stream to user devices, the networking component 204 may be configured to analyze various context associated with user devices and their connections to the online meeting. For example, the networking component 204 may be configured to determine whether a particular user device connected to the online meeting directly or indirectly (e.g., through another device). Such connection may also include connection through one or more gateways, application programming interfaces (APIs), etc.

Moreover, the networking component 204 may be configured to determine whether one or more software, computing, etc. elements of an online meeting software associated with the meeting service 202 are being used or not used by the user devices during the online meeting. For instance, the networking component 204 may be configured to determine that a particular user device connected to the online meeting without using the online meeting software (e.g., by calling into the meeting and not using an online meeting software application's interface).

Alternatively, or in addition to, the networking component 204 may be configured to determine whether one or more elements of the online meeting software has been turned off (e.g., a video is turned off, an audio is muted, a camera associated with a user device is unplugged, speakers associated with a user device are turned off/unplugged, etc.). In some example implementations, the component 204 may be configured to detect that the user is using a headset (e.g., a wireless, a wired, etc. headset) for audio during the online meeting and is no using a particular user device.

Additionally, the component 204 may detect user's activities on the user device connected to the online meeting. For example, a user interface window associated with the online meeting may be running in the foreground and/or background on the user device. If, for instance, the user interface window is running in the foreground, the component 204 may determine that the user is actively participating in the online meeting. This may further be confirmed, if the component 204 detects that the user is using elements of the online meeting software in the user interface window. However, if the user interface window is running in the background and/or the user is performing tasks that may be unrelated to the online meeting, the component 204 may determine that the user is not actively participating in the meeting and thus, may be configured to reduce quality, bandwidth, frequency, transmission rate, etc. and/or any other parameters of one or more data streams that are being delivered to the user device.

Further, the networking component 204 may be configured to determine that a certain software feature(s) of a third party application (e.g., a browser), using which the online meeting is being launched on the user device, is/are turned off and/or prevents use of various functionalities (e.g., audio, video, etc.) of the online meeting by the user of the user device. Moreover, the component 204 may be configured to detect hardware configuration of the user device, e.g., whether the user device has more than one monitor (e.g., allowing user to perform multiple tasks while participating in the meeting), whether a headset is connected to the user device and/or is being used by the user for audio purposes, whether an external camera is connected to the user device and/or is being used for video transmission purposes, etc. The component 204 may also account for networking configuration associated with user device(s) to determine how to optimize transmission of specific (e.g., audio, video, etc.) data streams to the user device(s).

FIG. 2b illustrates an exemplary system 210 for adjusting quality, bandwidth, frequency, transmission rate, etc. and/or other parameters associated with one or more data streams to users' devices in an online meeting based on detecting how user devices are receiving such data streams, according to some implementations of the current subject matter. The system 210 is similar to the system 200 shown in FIG. 2a and may be configured to include the meeting service 202, the networking component 204, user device 206 and user device 208 that may be associated with user 1. The system 210 may be configured to include a virtualized data application (VDA) 212 that may be configured to be communicatively coupled to the user devices 206 and 208 as well as the networking component 204. For ease of illustration only, the VDA 212 is shown in FIG. 2b as two separate instances VDA 212a coupled to the user device 206, and VDA 212b coupled to the user device 208. However, as can be understood, VDA 212 may be a single instance and/or multiple instances. The VDA 212 may be part of the networking component 204 and/or installed on one or both user devices 206, 208, for example, as a plug-in. The VDA 212 may be any combination of hardware and/or software. The VDA 212 may be instantiated together with instantiation of an online meeting session by a user device and may continue to run during such online meeting to monitor usage of specific data streams by each user device connected to the online meeting.

In some implementations, the VDA 212 may be configured to monitor contextual usage by the devices 206 and/or 208, e.g., whether a particular user device is using a video data stream, an audio data stream, etc. (e.g., listening to audio on one user device but not on the other user device, etc.) that is being transmitted to it from the networking component 204. For example, upon determining that the user device 206 is not actively using video data stream associated with the online meeting, the VDA 212 may be configured to transmit a notification to the networking component 204 to that effect, thereby allowing the networking component 204 to reduce quality, bandwidth, frequency, transmission rate, etc. and/or other parameters associated with the video data stream transmitted to the user device 206 and thus, transmit the reduced video data stream 211 to the user device 206. Similarly, the VDA 212 may be configured to determine that the user device 208 is not actively using audio data stream associated with the online meeting and transmit an appropriate notification to the networking component 204. Based on this notification, the networking component 204 may transmit the reduced audio data stream 213 to the user device 208.

FIG. 2c illustrates an exemplary system 220 for adjusting quality, bandwidth, frequency, transmission rate, etc. and/or other parameters associated with one or more data streams to users' devices in an online meeting based on detecting how user devices are receiving such data streams, according to some implementations of the current subject matter. The system 220 is similar to the system 210 shown in FIG. 2b. The system 220 may include the meeting service 202, the networking component 204, the user devices 206 and 208 associated with user 1, and the virtualized data application (VDA) 212. The VDA 212 may be a single instance that may be configured to be communicatively coupled to one of the user devices 206 and 208 (e.g., as shown in FIG. 2c, the VDA 212 may be coupled to the user device 208). The VDA 212 may be configured to analyze usage of various data streams associated with the online meeting by both devices 206, 208 and report them to the networking component 204. The networking component 204 may take appropriate actions with regard to adjusting quality, bandwidth, frequency, transmission rate, etc. and/or other parameters associated with one or more data streams, as discussed above. Further, as shown in FIG. 2c, the user device 206 may be configured to provide its usage of data streams to the device 208, which in turn, may be provided and/or detected by the VDA 212.

FIG. 2d illustrates an exemplary system 230 for adjusting quality, bandwidth, frequency, transmission rate, etc. and/or other parameters associated with one or more data streams to users' devices in an online meeting based on detecting how user devices are receiving such data streams, according to some implementations of the current subject matter. The system 230 is similar to the system 200 shown in FIG. 2a and may be configured to include the meeting service 202, the networking component 204, user device 206 and user device 208 that may be associated with user 1. Further, the system 230 may include local workspace applications 232a, 232b (collectively, applications 232) that may be configured to be locally installed on the user devices 206 and 208, respectively. The workspace applications 232 may be configured to monitor usage of data streams associated with the online meeting by their respective user devices 206, 208, and report such usage to the networking component 204. The workspace applications 232 may be configured to be executed in a background by the user devices 206, 208 for the purposes of monitoring of user's activities during the online meeting.

Similar to the VDA 212, the workspace applications 232 may be configured to monitor contextual usage by the user devices 206 and/or 208, e.g., whether the user of a particular user device is listening to audio on that user device but not on the other user devices, etc. as transmitted to it from the networking component 204. The applications 232 may be configured to report such usage to the networking component 204. The networking component 204 may then determine whether to reduce quality, bandwidth, frequency, transmission rate, etc. and/or other parameters associated with a specific data stream transmitted to the user devices 206, 208 and thus, transmit the reduced data streams 211, 213 to the user devices 206, 208, respectively.

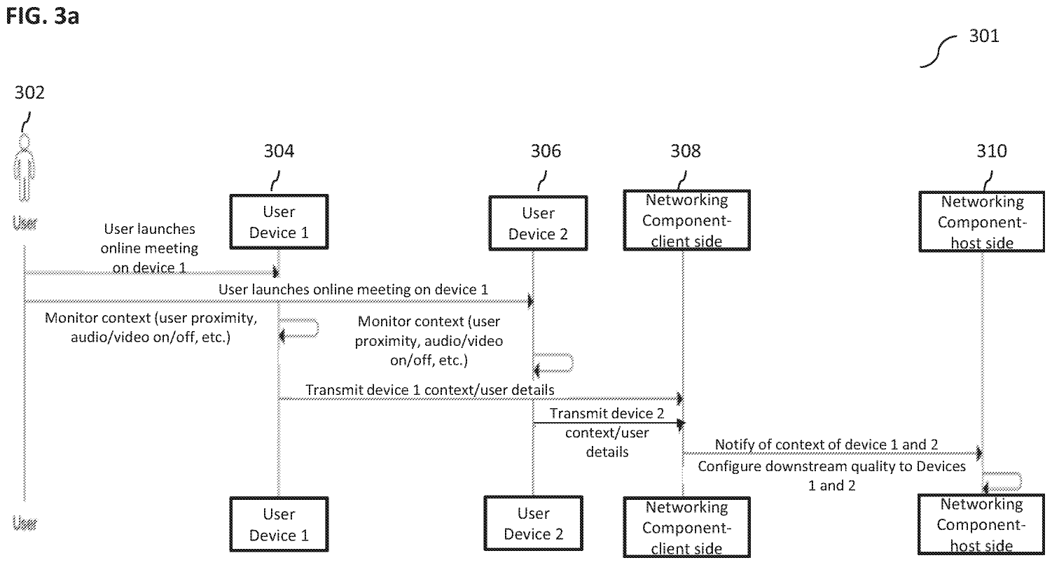

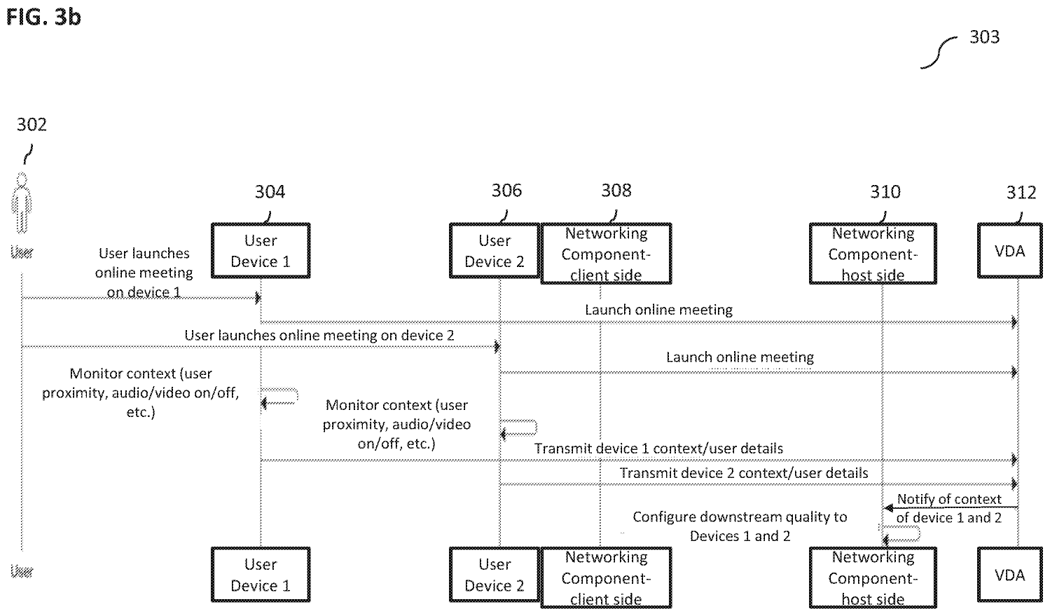

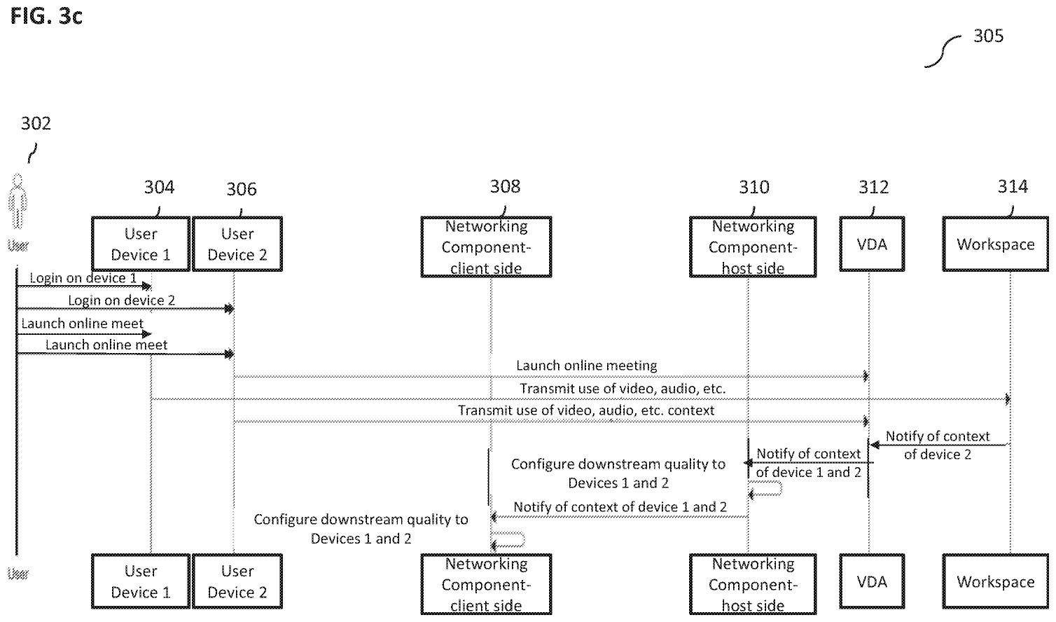

FIGS. 3a-c illustrate exemplary process flows 301-305, respectively, for adjusting quality, bandwidth, frequency, transmission rate, etc. and/or other parameters associated with one or more data streams to users' devices in an online meeting based on detecting how user devices are receiving such data streams, according to some implementations of the current subject matter.

Referring to FIG. 3a, the process flow 301 may be executed using user device 1 304 (similar to user device 206 above), user device 2 306 (similar to user device 208), a networking component's 204 client side component 308, and a networking component's 204 host side portion 310. The client side component 308 may be configured to be communicatively coupled to one or more user devices 306 and 308. The host side component 310 may be configured to be communicatively coupled to the online meeting service 202 (as shown in FIGS. 2a-d).

The process 301 may be initiated by a user 302 launching an online meeting application on device 304 and device 306. The launching may be simultaneous, sequential, etc. (or in any desired order). In some implementations, each of the devices 304, 306 may be configured to perform monitoring (e.g., through a local application, a plug-in, etc.) of user's proximity to the devices 304, 306, usage of audio, video, etc. components for receiving audio, video, etc. data streams transmitted from the meeting service 202 (not shown in FIG. 3a).

Each of the devices 304, 306 may be configured to transmit such contextual details and/or user details (e.g., user identification, IP addresses of devices, etc.) to the client side 308 of the networking component 204. The client side component 308 may then be configured to transmit notifications of the contextual usage of each device 304, 306 to the host side 310 of the networking component 204. Based on the contextual usage of each user device 304, 306, the host side 310 may configure downstream transmissions' (i.e., transmissions to devices 304, 306) quality, bandwidth, frequency, transmission rate, etc. and/or other parameters. In some exemplary implementations, the host side component 310 may be configured to perform a rebalancing function, whereby, for instance, a bandwidth that has been allocated for transmission of an audio data stream to device 304 may be reallocated for transmission of an audio data stream to device 306 in view of a determination that device 304 is not being used to receive audio data stream during the online meeting and device 306 is being actively used for these purposes.

Referring to FIG. 3b, the process flow 303 may be similar to the process flow 301, shown in FIG. 3a, and may be executed using user device 1 304, user device 2 306, the networking component's 204 client side component 308, the networking component's 204 host side portion 310, and the VDA 312 (which may be similar to the VDA 212 shown in FIGS. 2b, 2c).

Similar to the process 301, the process 303 may be initiated by the user 302 launching an online meeting application on devices 304 and 306. The devices 304, 306 may monitor user's proximity to the devices 304, 306, and/or usage of audio, video, etc. components for receiving audio, video, etc. data streams transmitted from the meeting service 202 (not shown in FIG. 3b). The launching of the online meeting may be triggered using the VDA application 312. Each of the devices 304, 306 may be configured to transmit such contextual details and/or user details (e.g., user identification, IP addresses of devices, etc.) to the VDA 312. The VDA 312 may then be configured to transmit notifications of the contextual usage of each device 304, 306 to the host side 310 of the networking component 204. Based on the contextual usage of each user device 304, 306 reported by the VDA 312, the host side 310 may configure downstream transmissions' quality, bandwidth, frequency, transmission rate, etc. and/or other parameters.

Referring to FIG. 3c, the process flow 305 may be similar to the process flow 303, shown in FIG. 3b, and may be executed using user device 1 304, user device 2 306, the networking component's 204 client side component 308, the networking component's 204 host side portion 310, the VDA 312 and a workspace application 314 (which may be similar to the workspace application shown in FIG. 2d).

The process 305 may be initiated by the user 302 logging into and launching an online meeting application on devices 304 and 306. The devices 304, 306 may monitor user's proximity to the devices 304, 306, and/or usage of audio, video, etc. components for receiving audio, video, etc. data streams transmitted from the meeting service 202 (not shown in FIG. 3c). The launching of the online meeting may be triggered using the VDA application 312. In some exemplary implementations, one of the user devices (e.g., device 304) may be configured to transmit various contextual details and/or user details to the VDA 312, while the other user device (e.g., device 306) may be configured to transmit such details to the workspace application 314. The workspace application 314 may then transmit the information that it received from device 306 to the VDA 312. The VDA 312 may combine information that it received from the workspace application 314 as well as the information that it received from the user device 304 and transmit appropriate notifications of the contextual usage of each device 304, 306 to the host side 310 of the networking component 204. Based on the contextual usage of each user device 304, 306 reported by the VDA 312, the host side 310 may configure downstream transmissions' quality, bandwidth, frequency, transmission rate, etc. and/or other parameters.

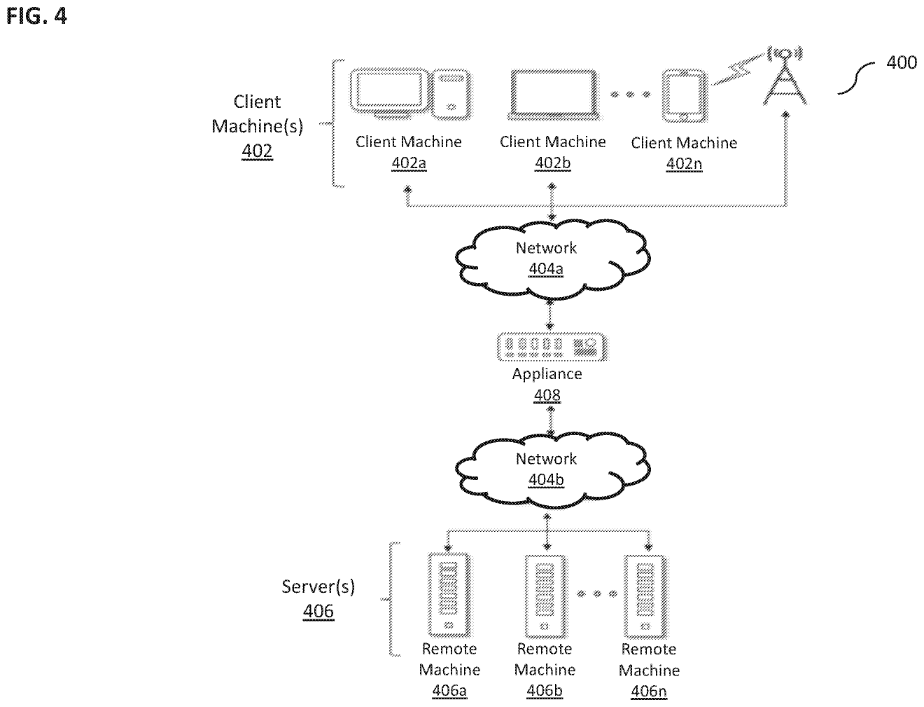

FIG. 4 illustrates an example of a network environment 400, according to some implementations of the current subject matter. Referring to FIGS. 1-3c, the network environment 400, in which various aspects of the disclosure may be implemented, may include one or more clients 402a-404n, one or more remote machines 406a-406n, one or more networks 404a and 404b, and one or more appliances 408 installed within the network environment 400. The clients 402a-402n communicate with the remote machines 406a-406n via the networks 404a and 404b.

In some example implementations, the clients 402a-402n may communicate with the remote machines 406a-406n via an appliance 408. The illustrated appliance 408 is positioned between the networks 404a and 404b, and may also be referred to as a network interface or gateway. In some example implementations, the appliance 408 may operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. In some example implementations, multiple appliances 408 may be used, and the appliance(s) 408 may be deployed as part of the network 404a and/or 404b.

The clients 402a-402n may be generally referred to as client machines, local machines, clients, client nodes, client computers, client devices, computing devices, endpoints, or endpoint nodes. One or more of the clients 402a-402n may implement, for example, the client device 102 and/or the like. The remote machines 406a-406n may be generally referred to as servers or a server farm. In some example implementations, a client 402 may have the capacity to function as both a client node seeking access to resources provided by a server 406 and as a server 406 providing access to hosted resources for other clients 402a-402n. The networks 404a and 404b may be generally referred to as a network 404. The network 404 including the networks 404a and 404b may be configured in any combination of wired and wireless networks.

The servers 406 may include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 406 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

In some example implementations, a server 406 may execute a remote presentation services program or other program that uses a thin-client or a remote-display protocol to capture display output generated by an application executing on a server 406 and transmit the application display output to a client 402.

In yet other example implementations, a server 406 may execute a virtual machine, such as the first virtual machine and/or the second virtual machine, to provide, for example, to the user at a client device, access to a computing environment such as the virtual desktop. The virtual machine may be managed by, for example, a hypervisor (e.g., a first hypervisor, a second hypervisor, and/or the like), a virtual machine manager (VMM), or any other hardware virtualization technique within the server 406.

In some example implementations, the network 404 may be a local-area network (LAN), a metropolitan area network (MAN), a wide area network (WAN), a primary public network, and/or a primary private network. Additional implementations may include one or more mobile telephone networks that use various protocols to communicate among mobile devices. For short-range communications within a wireless local-area network (WLAN), the protocols may include 1002.11, Bluetooth, and Near Field Communication (NFC).

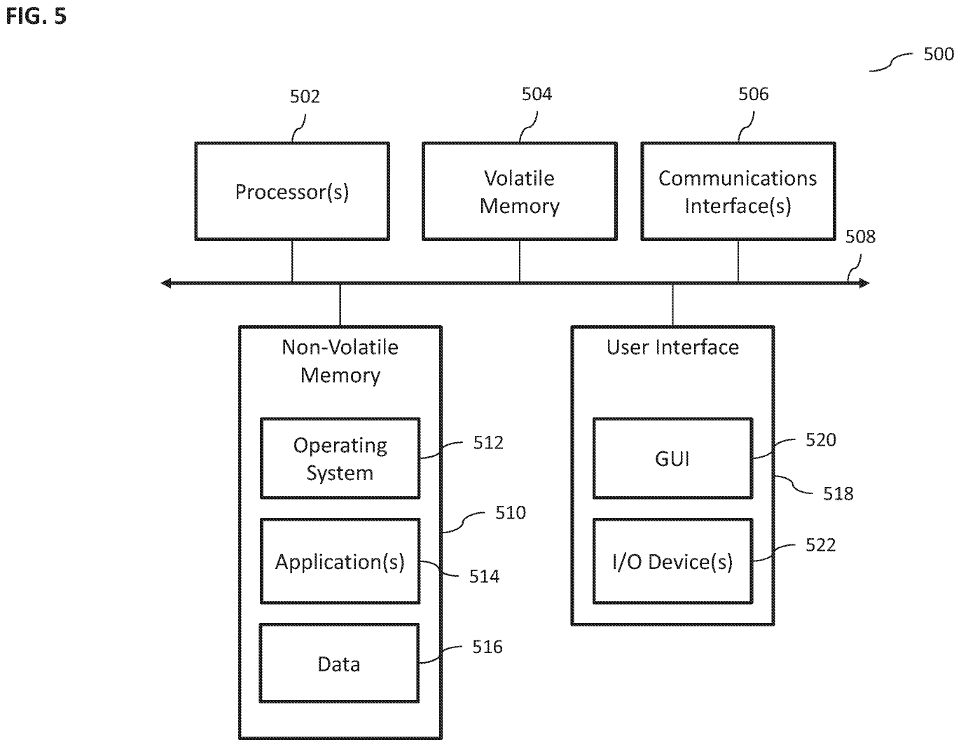

FIG. 5 depicts a block diagram illustrating an example of a computing device 500, in accordance with some example implementations. Referring to FIGS. 1-4, the computing device 500 may be useful for practicing an implementation of the system 100.

As shown in FIG. 5, the computing device 500 may include one or more processors 502, volatile memory 504 (e.g., RAM), non-volatile memory 510 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 518, one or more communications interfaces 506, and a communication bus 508. The user interface 518 may include a graphical user interface (GUI) 520 (e.g., a touchscreen, a display, and/or the like) and one or more input/output (I/O) devices 522 (e.g., a mouse, a keyboard, and/or the like). The non-volatile memory 510 may store an operating system 512, one or more applications 514, and data 516 such that computer instructions of the operating system 512 and/or applications 514 are executed by the processor(s) 502 out of the volatile memory 504. Data may be entered using an input device of the GUI 520 or received from I/O device(s) 522. Various elements of the computing device 500 may communicate via communication the communication bus 508. The computing device 500 as shown in FIG. 5 is shown merely as an example, and may be implemented by any computing or processing environment and with any type of machine or set of machines that may have suitable hardware and/or software capable of operating as described herein.

The processor(s) 502 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some example implementations, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some example implementations, the “processor” may be one or more physical processors or one or more “virtual” (e.g., remotely located or “cloud”) processors.

The communications interfaces 506 may include one or more interfaces to enable the computing device 500 to access a computer network such as a local area network (LAN), a wide area network (WAN), a public land mobile network (PLMN), and/or the Internet through a variety of wired and/or wireless or cellular connections.

As noted above, in some example implementations, one or more computing devices 500 may execute an application on behalf of a user of a client computing device (e.g., clients 402), may execute a virtual machine, which provides an execution session within which applications execute on behalf of a user or a client computing device (e.g., clients 402), such as a hosted desktop session (e.g., a virtual desktop), may execute a terminal services session to provide a hosted desktop environment, or may provide access to a computing environment including one or more of: one or more applications, one or more desktop applications, and one or more desktop sessions in which one or more applications may execute.

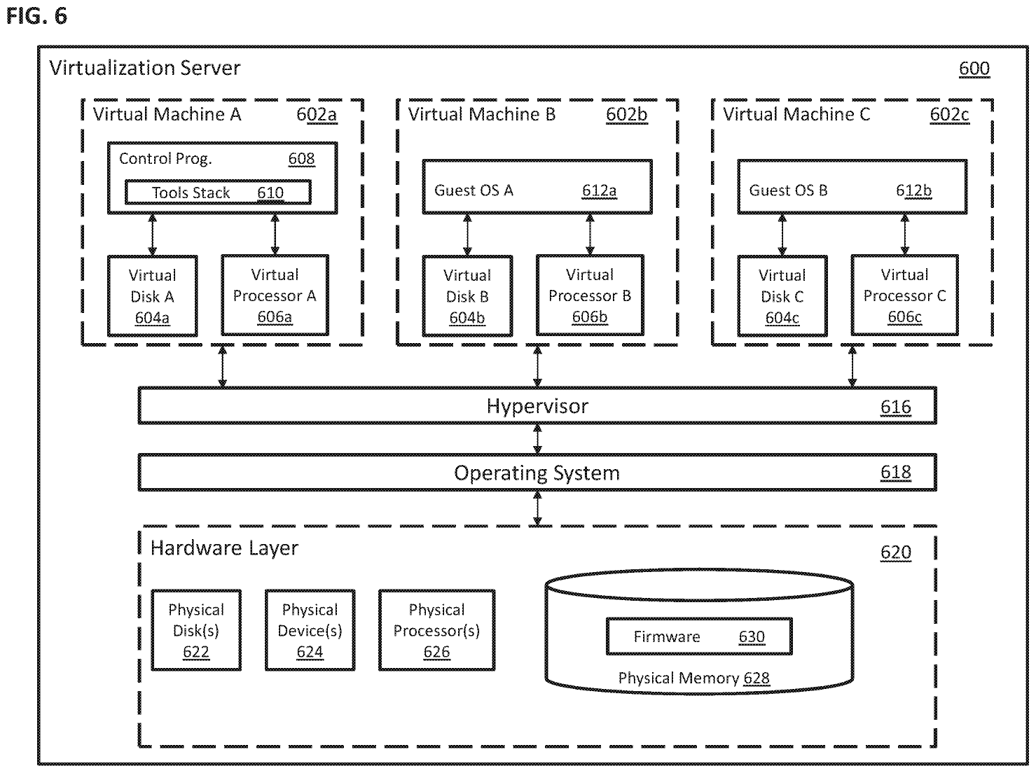

FIG. 6 illustrates a high-level architecture of an example of a virtualization system for implementing the computing system 100, in accordance with some example implementations. As shown in FIG. 6, the virtualization system may be a single-server or multi-server system, or a cloud system, including at least one virtualization server 600 configured to provide virtual desktops and/or virtual applications to one or more client access devices 402a-c. A desktop (or a virtual desktop) may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

Virtualization server 600 may be configured as a virtualization server in a virtualization environment, for example, a single-server, multi-server, or cloud computing environment. Virtualization server 600 illustrated in FIG. 6 may be deployed as and/or implemented by one or more implementations of server 406 illustrated in FIG. 4 or by other known computing devices. Included in virtualization server 600 is hardware layer 620 that may include one or more physical disks 622, one or more physical devices 624, one or more physical processors 626, and one or more physical memories 628. In some implementations, firmware 630 may be stored within a memory element in physical memory 628 and be executed by one or more of physical processors 626. Virtualization server 600 may further include operating system 618 that may be stored in a memory element in physical memory 628 and executed by one or more of physical processors 626. Still further, hypervisor 616 may be stored in a memory element in physical memory 628 and be executed by one or more of physical processors 626. Presence of operating system 618 may be optional.

Executing on one or more of physical processors 626 may be one or more virtual machines 602A-C (generally, 602). Each virtual machine 602 may have virtual disk 604A-C and virtual processor 606A-C. In some implementations, first virtual machine 602A may execute, using virtual processor 606A, control program 608 that includes tools stack 610. Control program 608 may be referred to as a control virtual machine, Domain 0, Dom0, or other virtual machine used for system administration and/or control. In some implementations, one or more virtual machines 602B-C may execute, using virtual processor 606B-C, guest operating system 612A-B (generally, 612).

Physical devices 624 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 600. Physical memory 628 in hardware layer 620 may include any type of memory. Physical memory 628 may store data, and in some implementations may store one or more programs, or set of executable instructions. FIG. 6 illustrates an implementation where firmware 630 is stored within physical memory 628 of virtualization server 600. Programs or executable instructions stored in physical memory 628 may be executed by the one or more processors 626 of virtualization server 600.

Virtualization server 600 may also include hypervisor 616. In some implementations, hypervisor 616 may be a program executed by processors 626 on virtualization server 600 to create and manage any number of virtual machines 602. Hypervisor 616 may be referred to as a virtual machine monitor, or platform virtualization software. In some implementations, hypervisor 616 may be any combination of executable instructions and hardware that monitors virtual machines 602 executing on a computing machine. Hypervisor 616 may be a Type 2 hypervisor, where the hypervisor executes within operating system 618 executing on virtualization server 600. Virtual machines may then execute at a layer above hypervisor 616. In some implementations, the Type 2 hypervisor may execute within the context of a user's operating system such that the Type 2 hypervisor interacts with the user's operating system. In other implementations, one or more virtualization servers 600 in a virtualization environment may instead include a Type 1 hypervisor (not shown). A Type 1 hypervisor may execute on virtualization server 600 by directly accessing the hardware and resources within hardware layer 620. That is, while Type 2 hypervisor 616 accesses system resources through host operating system 618, as shown, a Type 1 hypervisor may directly access all system resources without host operating system 618. A Type 1 hypervisor may execute directly on one or more physical processors 626 of virtualization server 600, and may include program data stored in physical memory 628.

Hypervisor 616, in some implementations, may provide virtual resources to guest operating systems 612 or control programs 608 executing on virtual machines 602 in any manner that simulates operating systems 612 or control programs 608 having direct access to system resources. System resources can include, but are not limited to, physical devices 624, physical disks 622, physical processors 626, physical memory 628, and any other component included in hardware layer 620 of virtualization server 600. Hypervisor 616 may be used to emulate virtual hardware, partition physical hardware, virtualize physical hardware, and/or execute virtual machines that provide access to computing environments. In still other implementations, hypervisor 616 may control processor scheduling and memory partitioning for virtual machine 602 executing on virtualization server 600. Examples of hypervisor 616 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 600 may execute hypervisor 616 that creates a virtual machine platform on which guest operating systems 612 may execute. When this is the case, virtualization server 600 may be referred to as a host server. An example of such a virtualization server is Citrix Hypervisor® provided by Citrix Systems, Inc., of Fort Lauderdale, Fla.

Hypervisor 616 may create one or more virtual machines 602B-C (generally, 602) in which guest operating systems 612 execute. In some implementations, hypervisor 616 may load a virtual machine image to create virtual machine 602. The virtual machine image may refer to a collection of data, states, instructions, etc. that make up an instance of a virtual machine. In other implementations, hypervisor 616 may execute guest operating system 612 within virtual machine 602. In still other implementations, virtual machine 602 may execute guest operating system 612.

In addition to creating virtual machines 602, hypervisor 616 may control the execution of at least one virtual machine 602. The hypervisor 616 may present at least one virtual machine 602 with an abstraction of at least one hardware resource provided by virtualization server 600 (e.g., any hardware resource available within hardware layer 620). In some implementations, hypervisor 616 may control the manner in which virtual machines 602 access physical processors 626 available in virtualization server 600. Controlling access to physical processors 626 may include determining whether virtual machine 602 should have access to processor 626, and how physical processor capabilities are presented to virtual machine 602.

As shown in FIG. 6, the virtualization server 600 may host or execute one or more virtual machines 602. Virtual machine 602 may be a set of executable instructions and/or user data that, when executed by processor 626, may imitate the operation of a physical computer such that virtual machine 602 can execute programs and processes much like a physical computing device. While FIG. 6 illustrates an implementation where virtualization server 600 hosts three virtual machines 602, in other implementations virtualization server 600 may host any number of virtual machines 602. Hypervisor 616 may provide each virtual machine 602 with a unique virtual view of the physical hardware, including memory 628, processor 626, and other system resources 622, 624 available to that virtual machine 602. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 616 may create one or more unsecure virtual machines 602 and one or more secure virtual machines 602. Unsecure virtual machines 602 may be prevented from accessing resources, hardware, memory locations, and programs that secure virtual machines 602 may be permitted to access. In other implementations, hypervisor 616 may provide each virtual machine 602 with a substantially similar virtual view of the physical hardware, memory, processor, and other system resources available to virtual machines 602.

Each virtual machine 602 may include virtual disk 604A-C (generally 604) and virtual processor 606A-C (generally 606.) Virtual disk 604 may be a virtualized view of one or more physical disks 622 of virtualization server 600, or a portion of one or more physical disks 622 of virtualization server 600. The virtualized view of physical disks 622 may be generated, provided, and managed by hypervisor 616. In some implementations, hypervisor 616 may provide each virtual machine 602 with a unique view of physical disks 622. These particular virtual disk 604 (included in each virtual machine 602) may be unique, when compared with other virtual disks 604.

Virtual processor 606 may be a virtualized view of one or more physical processors 626 of virtualization server 600. The virtualized view of physical processors 626 may be generated, provided, and managed by hypervisor 616. Virtual processor 606 may have substantially all of the same characteristics of at least one physical processor 626. Virtual processor 626 may provide a modified view of physical processors 626 such that at least some of the characteristics of virtual processor 606 are different from the characteristics of the corresponding physical processor 626.

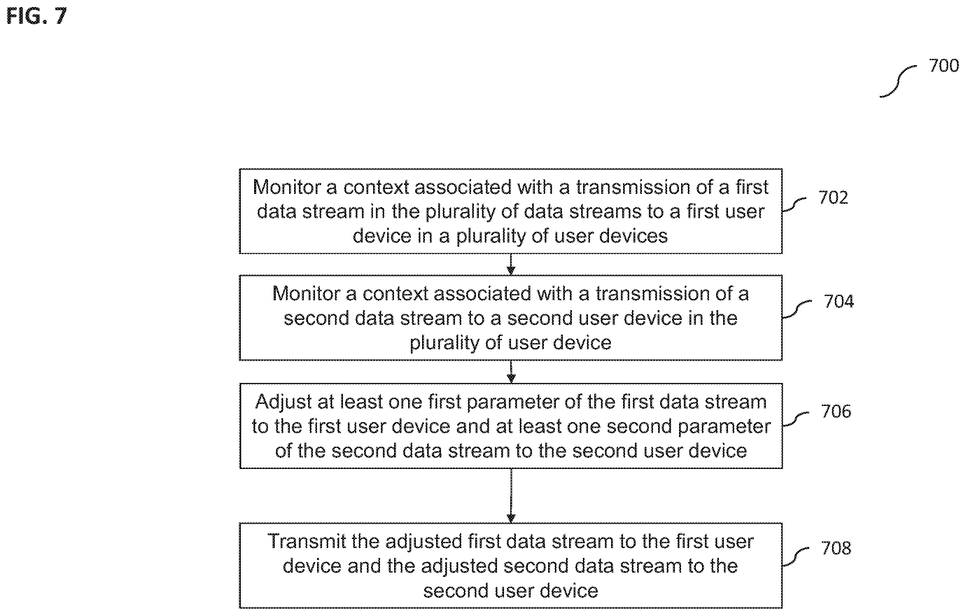

FIG. 7 illustrates an example of a method 700 for managing connections of user devices in a network-based conference (e.g., an online meeting), according to some implementations of the current subject matter. The method 700 may be performed by the system 100 shown in FIG. 1 and/or systems 200-230 shown in FIGS. 2a-d, respectively, using processes 301-305 shown in FIGS. 3a-c, respectively. For example, the process 700 may be executed using a networking component 104 (shown in FIG. 1) and/or 204 (shown in FIGS. 2a-d), wherein the networking component may be any combination of hardware and/or software, and may include a software-defined wide area networking (SD-WAN) component. The networking component may be configured to allow connection of various user devices (e.g., devices 102, 204, 206, etc.), that may belong to a single and/or multiple users, to a network-based conference provided by a meeting service server (e.g., service 106, 202).

At 702, the networking component may be configured to monitor a context (e.g., proximity of the user, audio/video being off/on, etc.) associated with a transmission of a first data stream (e.g., an audio data stream) in the plurality of data streams (e.g., audio, video, text, graphics, etc.) to a first user device (e.g., device 206 shown in FIGS. 2a-d) in a plurality of user devices. The monitoring may be performed by obtaining various data from the user device (e.g., either using a VDA 212 component, a workspace component 232, and/or in any other way).

At 704, the networking component may also be configured to monitor a context (e.g., proximity of the user, audio/video being off/on, etc.) associated with a transmission of a second data stream to a second user device in the plurality of user devices. The second data stream may also be the same type of data stream (e.g., audio) and may be configured to transmit the same information that is being transmitted to the first user device (e.g., both may be audio data streams from the online service 106). As stated above, the first and second user devices may be communicatively connected to a network-based conference (i.e., an online meeting).

At 706, the networking component may be configured to adjust, based on the monitoring of the context associated with respective transmissions of the first data stream and the second data stream, at least one first parameter (e.g., quality, bandwidth, frequency, data rate, etc.) of the first data stream to the first user device and at least one second parameter of the second data stream to the second user device. For example, as shown in FIG. 2a, the quality of audio data transmitted to the second user device 208 may be reduced as it may be determined that the user is not using device 208 for listening to the audio associated with the online meeting and instead is using device 206 for that purpose. In some cases, the quality of audio data transmitted to the first user device 206 may be increased and/or enhanced.

At 708, the networking component may be configured to transmit, based on the adjusting (e.g., using the reduced/enhanced quality, bandwidth, etc.), the adjusted first data stream to the first user device and the adjusted second data stream to the second user device.

In some implementations, the current subject matter can include one or more of the following optional features. The plurality of data streams may include at least one of the following: an audio data stream, a video data stream, a graphical data stream, a text data stream, and any combination thereof.

In some implementations, the first user device and the second user device may be configured to be used by a user (e.g., a single user) for communicatively connecting to the network-based conference. The monitoring of the contexts of respective transmissions of the first and second data streams may include at least one of the following: determining a capability of at least one of the first and second devices for receiving the respective first and second data streams, determining a use of at least one of the first and second devices by the user for receiving the respective first and second data streams, and any combination thereof. The use of the first and/or second devices by the user may include a contextual use of at least of the first and second devices during the network-based conference. The monitoring of the contexts of respective transmissions of the first and second data streams may include determining presence (e.g., physical presence) of the user proximate to at least one of the first and second user devices.

In some implementations, the first parameter may include at least one of the following parameters: a quality, a bandwidth, a frequency, a transmission rate, and any combination thereof, associated with respective transmissions of the first and second data streams to the first and second user devices. Adjusting of the first parameter may include at least one of allocating, reducing or unchanging, based on the monitoring of the contexts of respective transmissions of the first and second data streams, at least one of the quality, the bandwidth, the frequency, the transmission rate, and any combination thereof associated with respective transmissions of the first and second data streams to at least one of the first and second user devices.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
monitoring, using at least one processor, a first context associated with a first transmission of a first data stream in plurality of data streams to a first user device in a plurality of user devices, the first context being indicative of a first active perception level of the first data stream;
monitoring, using the at least one processor, a second context associated with a second transmission of a second data stream to a second user device in the plurality of user devices, the first and second user devices being communicatively connected to a network-based conference, the second context being indicative of a second active perception level of the second data stream;
adjusting, using the at least one processor, based on the monitoring of the first context and the second context associated with respective transmissions of the first data stream and the second data stream, at least one first parameter of the first data stream to the first user device and at least one second parameter of the second data stream to the second user device; and
transmitting, using the at least one processor, the adjusted first data stream to the first user device and the adjusted second data stream to the second user device.

2. The computer-implemented method of claim 1, wherein the plurality of data streams comprises at least one of: an audio data stream, a video data stream, a graphical data stream, a text data stream, and any combination thereof.

3. The computer-implemented method of claim 1, wherein the first user device and the second user device are configured to be used by a user for communicatively connecting to the network-based conference.

4. The computer-implemented method of claim 3, wherein the monitoring of the first context and the second context associated with respective transmissions of the first and second data streams comprise at least one of:
determining a capability of at least one of the first and second devices for receiving the respective first and second data streams;
determining a use of at least one of the first and second devices by the user for receiving the respective first and second data streams; and
any combination thereof.

5. The computer-implemented method of claim 4, wherein the use of the at least one of the first and second devices by the user comprises a contextual use of at least of the first and second devices during the network-based conference.

6. The computer-implemented method of claim 4, wherein the monitoring of the first context and the second context associated with respective transmissions of the first and second data streams comprise determining presence of a user proximate to at least one of the first and second user devices.

7. The computer-implemented method of claim 1, wherein the at least one first parameter comprises at least one of: a quality, a bandwidth, a frequency, a transmission rate, and any combination thereof, associated with respective transmissions of the first and second data streams to the first and second user devices.

8. The computer-implemented method of claim 7, wherein the adjusting comprises at least one of allocating, reducing or unchanging, based on the monitoring of the first context and the second context of respective transmissions of the first and second data streams, at least one of the quality, the bandwidth, the frequency, the transmission rate, and any combination thereof associated with respective transmissions of the first and second data streams to at least one of the first and second user devices.

9. A system comprising:
at least one programmable processor; and
a non-transitory machine-readable medium storing instructions that, when executed by the at least one programmable processor, cause the at least one programmable processor to perform operations comprising:
monitoring a first context associated with a first transmission of a first data stream in plurality of data streams to a first user device in a plurality of user devices, the first context being indicative of a first active perception level of the first data stream;
monitoring a second context associated with a second transmission of a second data stream to a second user device in the plurality of user devices, the first and second user devices being communicatively connected to a network-based conference, the second context being indicative of a second active perception level of the second data stream;
adjusting, based on the monitoring of the first context and the second context associated with respective transmissions of the first data stream and the second data stream, at least one first parameter of the first data stream to the first user device and at least one second parameter of the second data stream to the second user device; and
transmitting the adjusted first data stream to the first user device and the adjusted second data stream to the second user device.

10. The system of claim 9, wherein the plurality of data streams comprises at least one of: an audio data stream, a video data stream, a graphical data stream, and a text data stream.

11. The system of claim 9, wherein the first user device and the second user device are configured to be used by a user for communicatively connecting to the network-based conference.

12. The system of claim 11, wherein the monitoring of the first context and the second context associated with respective transmissions of the first and second data streams comprise at least one of:
determining a capability of at least one of the first and second devices for receiving the respective first and second data streams; and
determining a use of at least one of the first and second devices by the user for receiving the respective first and second data streams.

13. The system of claim 12, wherein the use of the at least one of the first and second devices by the user comprises a contextual use of at least of the first and second devices during the network-based conference.

14. The system of claim 12, wherein the monitoring of the first context and the second context associated with respective transmissions of the first and second data streams comprise determining presence of a user proximate to at least one of the first and second user devices.

15. The system of claim 9, wherein the at least one first parameter comprises at least one of: a quality, a bandwidth, a frequency, and a transmission rate.

16. The system of claim 15, wherein the adjusting comprises at least one of allocating, reducing or unchanging, based on the monitoring of the first context and the second context of respective transmissions of the first and second data streams, at least one of the quality, the bandwidth, the frequency, and the transmission rate.

17. A computer program product comprising a non-transitory machine-readable medium storing instructions that, when executed by at least one programmable processor, cause the at least one programmable processor to perform operations comprising:
monitoring a first context associated with a first transmission of a first data stream in plurality of data streams to a first user device in a plurality of user devices, the first context being indicative of a first active perception level of the first data stream;
monitoring a second context associated with a second transmission of a second data stream to a second user device in the plurality of user devices, the first and second user devices being communicatively connected to a network-based conference, the second context being indicative of a second active perception level of the second data stream;
adjusting, based on the monitoring of the first context and the second context associated with respective transmissions of the first data stream and the second data stream, at least one first parameter of the first data stream to the first user device and at least one second parameter of the second data stream to the second user device; and
transmitting the adjusted first data stream to the first user device and the adjusted second data stream to the second user device.

18. The computer program product of claim 17, wherein the plurality of data streams comprises at least one of: an audio data stream, a video data stream, a graphical data stream, and a text data stream, wherein the first user device and the second user device are configured to be used by a user for communicatively connecting to the network-based conference.

19. (canceled)

20. The computer program product of claim 17, wherein the monitoring of the first context and the second context associated with respective transmissions of the first and second data streams comprise at least one of:
determining a capability of at least one of the first and second devices for receiving the respective first and second data streams;
determining a use of at least one of the first and second devices for receiving the respective first and second data streams; and
determining a presence of a user proximate to at least one of the first and second user devices, wherein the use of the at least one of the first and second devices comprises a contextual use of at least of the first and second devices during the network-based conference.

21-22. (canceled)

23. The computer program product of claim 17, wherein the at least one first parameter comprises at least one of: a quality, a bandwidth, a frequency, a transmission rate, and any combination thereof, associated with respective transmissions of the first and second data streams to the first and second user devices, wherein the adjusting comprises at least one of allocating, reducing or unchanging, based on the monitoring of the first context and the second context of respective transmissions of the first and second data streams, at least one of the quality, the bandwidth, the frequency, the transmission rate, and any combination thereof associated with respective transmissions of the first and second data streams to at least one of the first and second user devices.

24. (canceled)
